(19) United States
(12) Patent Application Publication
(10) Pub. No.: US 2026/0212559 A1
(43) Pub. Date: Jul. 23, 2026

(54) Text-to-Image Generation via Masked Generative Transformers

(71) Applicant: Google LLC, Mountain View, CA (US)

(72) Inventors: Aaron Joseph Maschinot, Somerville, MA (US); Huiwen Chang, Jersey City, NJ (US); Dilip Krishnan, Arlington, MA (US); Han Zhang, Sunnyvale, CA (US); Jarred Paul Barber, Watertown, MA (US); Yuanzhen Li, Newton Centre, MA (US); José Lezama Torres de la Llosa, Atlanta, GA (US); Michael Rubinstein, Natick, MA (US)

(21) Appl. No.: 19/139,797

(22) PCT Filed: Dec. 15, 2023
(86) PCT No.: PCT/US2023/084316

§ 371 Date: Jun. 16, 2025

Related U.S. Application Data
(60) Provisional application No. 63/433,311, filed on Dec. 16, 2022.

(51) Int. Cl. G06T 11/60; G06F 40/284; G06F 40/40; G06T 3/4053

(52) U.S. Cl. CPC G06T 11/60; G06F 40/284; G06F 40/40; G06T 3/4053

(57) ABSTRACT

Provided are text-to-image Transformer models that achieve state-of-the-art image generation performance while being significantly more efficient than diffusion or autoregressive models. Some example models described herein can be trained on a masked modeling task in discrete token space. Given the text embedding extracted from a pre-trained large language model (LLM), example models can be trained to predict randomly masked image tokens. Compared to pixel-space diffusion models, such as Imagen and DALL-E 2, example models described herein are significantly more efficient due to the use of discrete tokens. Compared to autoregressive models, such as Parti, example models described herein are more efficient due to the use of parallel decoding. The use of a pre-trained LLM enables fine-grained language understanding, translating to high-fidelity image generation and the understanding of visual concepts such as objects, their spatial relationships, pose, cardinality etc.

### RELATED APPLICATIONS

This application claims priority to and the benefit of U.S. Provisional Patent Application No. 63/433,311, filed Dec. 16, 2022. U.S. Provisional Patent Application No. 63/433,311 is hereby incorporated by reference in its entirety.

### FIELD

The present disclosure relates generally to machine learning. More particularly, the present disclosure relates to text-to-image generation via masked generative transformers.

### BACKGROUND

In the field of computer vision and natural language processing, the task of text-to-image generation refers to the generation of high-quality images from textual descriptions. Despite recent advancements in deep learning and artificial intelligence, the task of creating realistic images that accurately represent the semantic content of a given textual input remains a complex and computationally intensive problem.

Certain existing techniques for text-to-image generation, such as diffusion or autoregressive models, are effective to generate images from textual prompts. However, these methods often require substantial computational resources and numerous sampling iterations, which lead to significant inefficiencies and delays in the image generation process. This hampers their practical applicability, particularly in real-time or high-throughput applications.

Moreover, existing models usually operate in pixel-space, which further complicates the computational process and increases resource demands. These models also struggle to maintain a fine-grained understanding of language, which often results in less accurate and lower fidelity image generation. This inability to accurately represent complex visual concepts such as objects, spatial relationships, pose, cardinality, and others based on textual descriptions (a concept which may be referred to as “text-and-image alignment”) is a drawback of these conventional text-to-image generation models.

Furthermore, when it comes to image editing applications like inpainting, outpainting, and mask-free editing, current models often require additional fine-tuning or inversion, adding another layer of complexity and computational demand. This makes them less than ideal for real-time or on-demand image editing tasks.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computing system configured to perform text-to-image generation with improved computational efficiency. The computing system also includes one or more processors. The system also includes one or more non-transitory computer-readable media that collectively store: a machine-learned text-to-image generation model which may include a base visual token prediction model, a super-resolution visual token prediction model, and a visual token decoder model. The one or more non-transitory computer-readable media also store instructions that, when executed by the computing system, cause the computing system to perform operations. The operations includes obtaining a text embedding associated with a textual prompt that textually describes image content. The operations also includes processing the text embedding with the base visual token prediction model to predict one or more of a first set of latent visual tokens that are associated with a first resolution. The operations also includes processing the first set of latent visual tokens with the super-resolution visual token prediction model to generate one or more of a second set of latent visual tokens that are associated with a second resolution, the second resolution being greater than the first resolution. The operations also includes processing the second set of latent visual tokens with the visual token decoder model to generate a synthetic image, where the synthetic image depicts image content textually described by the textual prompt. Other embodiments of this aspect include corresponding computer systems, apparatus, and computer programs recorded on one or more computer storage devices, each configured to perform the actions of the methods.

One general aspect includes a computer-implemented method to train a text-to-image generation model. The computer-implemented method includes obtaining, by a computing system may include one or more computing devices, a training tuple may include a textual prompt and a training image that depicts content described by the textual prompt. The method also includes processing, by the computing system, a lower-resolution version of the training image with a first tokenizer model to generate a first set of conditioning tokens. The method also includes masking, by the computing system, one or more of the first set of conditioning tokens to generate a first set of masked tokens. The method also includes processing, by the computing system, the first set of masked tokens with the base visual token prediction model conditioned on the text embedding to predict one or more of a first set of latent visual tokens that are associated with a first resolution. The method also includes training, by the computing system, the base visual token prediction model using a first loss function that compares the one or more of the first set of conditioning tokens that were masked with the one or more of the first set of latent visual tokens that are predicted by the base visual token prediction model. The method also includes processing, by the computing system, a higher-resolution version of the training image with a second tokenizer model to generate a second set of conditioning tokens. The method also includes masking, by the computing system, one or more of the second set of conditioning tokens to generate a second set of masked tokens. The method also includes processing, by the computing system, the second set of masked tokens and the first set of latent visual tokens with the super-resolution visual token prediction model to generate one or more of a second set of latent visual tokens that are associated with a second resolution, the second resolution being greater than the first resolution. The method also includes training, by the computing system, the super-resolution visual token prediction model using a second loss function that compares the one or more of the second set of conditioning tokens that were masked with the one or more of the second set of latent visual tokens that are generated by the super-resolution visual token prediction model. Other embodiments of this aspect include corresponding computer systems, apparatus, and computer programs recorded on one or more computer storage devices, each configured to perform the actions of the methods.

One general aspect includes one or more non-transitory computer-readable media that collectively store a text-to-image generation model, the text-to-image generation model comprising a base visual token prediction model and a super-resolution visual token prediction model, the text-to-image generation model having been trained by performance of training operations. The training operations includes obtaining, by a computing system may include one or more computing devices, a training tuple may include a textual prompt and a training image that depicts content described by the textual prompt. The training operations also includes processing, by the computing system, a lower-resolution version of the training image with a first tokenizer model to generate a first set of conditioning tokens. The training operations also includes masking, by the computing system, one or more of the first set of conditioning tokens to generate a first set of masked tokens. The training operations also includes processing, by the computing system, the first set of masked tokens with the base visual token prediction model conditioned on the text embedding to predict one or more of a first set of latent visual tokens that are associated with a first resolution. The training operations also includes training, by the computing system, the base visual token prediction model using a first loss function that compares the one or more of the first set of conditioning tokens that were masked with the one or more of the first set of latent visual tokens that are predicted by the base visual token prediction model. The training operations also includes processing, by the computing system, a higher-resolution version of the training image with a second tokenizer model to generate a second set of conditioning tokens. The training operations also includes masking, by the computing system, one or more of the second set of conditioning tokens to generate a second set of masked tokens. The training operations also includes processing, by the computing system, the second set of masked tokens and the first set of latent visual tokens with the super-resolution visual token prediction model to generate one or more of a second set of latent visual tokens that are associated with a second resolution, the second resolution being greater than the first resolution. The training operations also includes training, by the computing system, the super-resolution visual token prediction model using a second loss function that compares the one or more of the second set of conditioning tokens that were masked with the one or more of the second set of latent visual tokens that are generated by the super-resolution visual token prediction model. Other embodiments of this aspect include corresponding computer systems, apparatus, and computer programs recorded on one or more computer storage devices, each configured to perform the actions of the methods.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of an example framework for training example models according to example embodiments of the present disclosure.

FIG. 2 depicts a graphical diagram of an example framework for performing image generation using example models according to example embodiments of the present disclosure.

FIG. 3 depicts a graphical diagram of an example architecture of an example super-resolution model according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

### Overview

Example aspects of the present disclosure are directed to a text-to-image generation model that offers substantial improvements in image generation performance and computational efficiency. Prior techniques, such as diffusion or autoregressive models, while effective, often require extensive computational resources and sampling iterations. The systems and methods described herein address these challenges by implementing a masked modeling task in discrete token space, which significantly enhances the model's efficiency.

Specifically, example implementations of the present disclosure leverage a pre-trained large language model (LLM) to extract text embeddings, which are then used to predict randomly masked image tokens. This approach not only enhances the model's efficiency but also enables fine-grained language understanding, translating to high-fidelity image generation and the understanding of visual concepts such as objects and their spatial relationships, pose, cardinality, etc.

The proposed image generation models can include a sequence of models. These can include a pair of “tokenizer” models (e.g.. VQGAN, VQVAE, etc.), a base visual token prediction model, and a super-resolution visual token prediction model. These components work together to create a powerful and efficient system for generating high-quality images from text prompts.

Moreover, the proposed models are significantly faster than comparable models due to the utilization of quantized image tokens and parallel decoding. This improves computational efficiency without compromising the quality of the generated images or the semantic understanding of the input text prompt. The proposed models can be applied to perform a range of image editing applications, including inpainting, outpainting, and mask-free editing, without the need for fine-tuning or inverting the model.

More particularly, one example aspect of the present disclosure is directed to a highly efficient text-to-image generation model that can be used for various image editing applications. This model, example implementations of which can be referred to as ‘Muse’, is designed to generate high-fidelity images from textual prompts. The model can be trained on a masked modeling task in discrete token space, where it is trained to predict randomly masked image tokens given a text embedding extracted from a pre-trained large language model (e.g., LLM). The use of discrete tokens and fewer sampling iterations make this model significantly more efficient than pixel-space diffusion models such as Imagen and DALL-E 2. Thus, in some cases, the proposed approach can be referred to as “discrete diffusion.”

One example aspect is directed to the use of a pre-trained text encoder (e.g., LLM) for extracting text embeddings. This approach enables the model to have a fine-grained understanding of language, which translates to high-fidelity image generation. The model can understand visual concepts such as objects, their spatial relationships, pose, cardinality, and so on. For instance, given a text prompt describing a ‘red apple on a table’, the model can generate an image accurately depicting this scenario.

Another example aspect is directed to the use of parallel decoding, which makes the proposed approach more efficient than autoregressive models. For example, compared to certain existing autoregressive models, example implementations of the present disclosure can generate images faster due to its ability to predict and/or decode multiple image tokens in parallel. This significantly reduces the time required to generate an image from a given text prompt. The proposed approach also more efficient than plain “vanilla” diffusion approaches. In particular, via parallel diffusion, example models proposed herein can predict multiple final token values in one forward pass of the model. Standard text-to-image diffusion can predict multiple pixels in one forward pass, but those predictions aren't final—diffusion typically needs to feed those predictions back in as inputs to a sequence of forward passes to generate the final pixels.

Another example aspect of the present disclosure is directed to a new framework for learning to perform text-to-image synthesis using a masked image modeling approach. In particular, example implementations of the present disclosure can apply a cascaded visual token prediction approach that includes both a base visual token prediction model and a super-resolution visual token prediction model. The base model can take a sequence of partially masked low-resolution tokens and predict the marginal distribution for each masked token, conditioned on the unmasked tokens and a text embedding. The super-resolution visual token prediction model, on the other hand, can translate unmasked low-resolution tokens into high-resolution tokens, again conditioned on text embeddings.

In terms of image editing capabilities, the proposed model can be used to perform for a number of zero-shot image editing capabilities. This includes inpainting, outpainting, and mask-free editing. These capabilities are enabled by the mask-based training approach, which allows the model to learn to predict masked tokens given a set of conditioning tokens generated by vector-quantized tokenization models.

Thus, the present disclosure describes a highly efficient text-to-image generation model that leverages pre-trained large language models, masked image modeling, variable masking rates, and/or classifier-free guidance to generate high-quality images from textual prompts. The model's efficiency and image editing capabilities make it applicable to various use cases in the field of computer vision and natural language processing.

The systems and methods of the present disclosure provide a number of technical solutions to technical problems in the field of computer vision and natural language processing. One example technical challenge is the generation of high-quality images from textual descriptions. This technical problem has posed significant challenges due to the complex and computationally intensive nature of creating realistic images that accurately map the semantic content of a given textual input. Conventional techniques such as diffusion or autoregressive models, while effective, have been hindered by high computational resources requirements and numerous sampling iterations. This has resulted in significant inefficiencies and delays in the image generation process, limiting their practical applicability in real-time or high-throughput applications.

The technology proposed herein offers a technical solution to this technical problem. By implementing a masked modeling task in discrete token space, the model's efficiency is significantly enhanced. This approach drastically reduces the necessity for extensive computational resources and sampling iterations, thereby addressing the key limitations of existing methods. This technical solution does not necessitate compromise on the quality of the generated images or the semantic understanding of the input text prompt, demonstrating a balance between computational efficiency and performance effectiveness.

Furthermore, the proposed technology not only improves the efficiency of image generation but also enhances its accuracy and fidelity. By leveraging a pre-trained large language model to extract text embeddings and predict randomly masked image tokens, the model achieves fine-grained language understanding. This translates to high-fidelity image generation and a comprehensive understanding of visual concepts such as objects and their spatial relationships, pose, cardinality, among others.

In addition, the proposed technology also provides a solution to the technical problem of image editing. Current models often require additional fine-tuning or inversion which adds to the computational demand. The proposed model, however, can perform a range of image editing applications, including inpainting, outpainting, and mask-free editing, without the need for fine-tuning or inverting the model.

The technology proposed herein has numerous practical applications, as it can be used to generate high-quality images from textual prompts, which can be useful in a wide range of scenarios. For instance, it can be used to generate images to accompany various forms of textual content, eliminating the need for manual image sourcing or creation. As another example, the technology can be used in educational settings, where it can generate images based on textual descriptions to aid learning and comprehension. It could also be employed in entertainment and gaming applications, where it could generate images for character designs, scenes, and other visual elements based on textual descriptions. As vet another example, the technology proposed herein has significant potential in image editing applications. For instance, it can be used for inpainting, outpainting, and mask-free editing, making it extremely useful for photo retouching, restoration, and other image editing tasks.

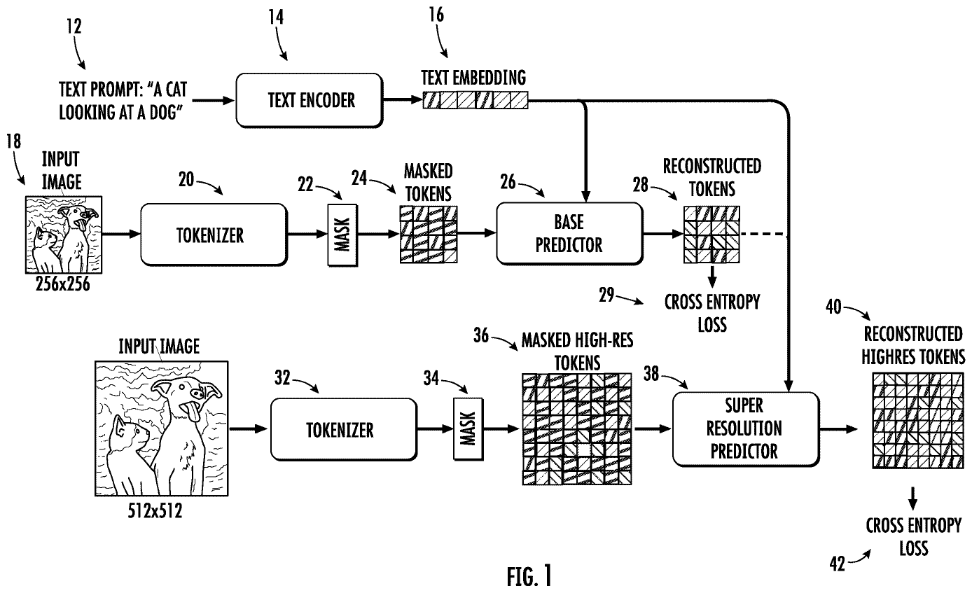

FIG. 1 illustrates an example text-to-image generation model and an example framework employed to train the model. An initial step of the training process, as depicted in FIG. 1, involves the acquisition of a training tuple by a computing system, which can include one or more computing devices. This training tuple includes a textual prompt (marked as 12 in the figure) and a corresponding training image that visually represents the content described by the textual prompt. The textual prompt can be in any language or script and can contain various types of descriptions, ranging from simple object descriptions to complex scene narratives.

Subsequently, the computing system processes the textual prompt with a text encoder, labeled as 14 in FIG. 1. This text encoder can be a pre-existing language model, such as Google's T5 model, trained on a large corpus of text data. The text encoder takes the textual prompt and transforms it into a text embedding, labeled as 16 in FIG. 1. This text embedding can be a numerical representation of the textual prompt in a latent space, capturing its semantic and syntactic information.

Once the text embedding is generated, the computing system then processes a lower-resolution version of the training image, depicted as 18 in FIG. 1. This processing is accomplished with a first tokenizer model, marked as 20 in the figure. As one example, this tokenizer model can be an image encoder, such as a VQGAN (Vector Quantized Generative Adversarial Networks) model, which is trained to convert images into sequences of discrete tokens. The tokenizer model generates a first set of conditioning tokens, which serve as an intermediate representation of the image. The tokenizer can produce the tokens in a quantized space. Having a (quantized) list of possible token values instead of a continuum of possible values allows a cross entropy loss to be applied to the encoder outputs, as discussed further elsewhere herein.

The VQGAN model can include an encoder and decoder, with a quantization layer that converts an input image into a sequence of tokens from a learned codebook. In some implementations, the encoder and decoder can be built entirely with convolutional layers to support encoding images of different resolutions. Two VQGAN models can be trained, one with a downsampling ratio of 16, and the other with a ratio of 8, to obtain tokens for the base model and super-resolution model respectively. These tokens, being discrete in nature, allow the use of a cross-entropy loss at the output for predicting masked tokens in the subsequent stage.

Referring still to FIG. 1, in the next step depicted as 22 in FIG. 1, the computing system randomly masks one or more of the first set of conditioning tokens, generating a first set of masked tokens, labeled as 24. This masking process is done to create an incomplete representation of the image, which the model will then attempt to complete in subsequent steps.

The first set of masked tokens is then processed by a base visual token prediction model, marked as 26 in FIG. 1. This model is conditioned on the text embedding generated earlier. The base visual token prediction model is trained to predict the masked tokens, generating a first set of latent visual tokens (28 in FIG. 1) that are associated with the lower-resolution version of the image. This prediction takes into account both the masked visual tokens and the text embedding, essentially bridging the gap between the textual description and the visual representation.

In some implementations, the base predictor model 26 can be a masked transformer, with inputs being the projected text embeddings and image tokens. The image tokens can be randomly masked and replaced with a special [MASK]token. The base model can employ several transformer layers, including a self-attention block, cross-attention block, and MLP block to extract features. An MLP can be used at the output layer to convert each masked image embedding into a set of logits corresponding to a VQGAN codebook size.

Training of the base visual token prediction model 26 can be accomplished using a first loss function, represented as 29 in FIG. 1. This loss function compares the tokens that were masked from the first set of conditioning tokens with the predicted tokens from the first set of latent visual tokens. This comparison aids in the refinement of the prediction model, ensuring that the predicted tokens accurately represent the masked tokens. As one example, a cross-entropy loss can be applied with the ground truth token label as the target. The base model 26 can be trained to predict all masked tokens at each step during training. However, for inference, mask prediction can be performed in an iterative manner, significantly increasing the quality.

The computing system can also process a higher-resolution version of the training image, depicted as 30 in FIG. 1. This processing can be done using a second tokenizer model, marked as 32 in the figure. Much like the first tokenizer model, this second tokenizer model also generates a set of conditioning tokens, but these tokens are associated with a higher-resolution version of the image.

Similar to the previous masking step, the computing system then masks one or more of the second set of conditioning tokens, generating a second set of masked tokens, labeled as 36 in FIG. 1. These masked tokens, along with the first set of latent visual tokens, are then processed by a super-resolution visual token prediction model, marked as 38 in the figure. This model generates a second set of latent visual tokens (40 in FIG. 1) that are associated with the higher-resolution version of the image. This super-resolution model essentially translates or maps the lower-resolution tokens generated by the base visual token prediction model into the higher-resolution tokens.

In particular, in some implementations the proposed framework can incorporate VQGAN models, one at 16×16 latent resolution and 256×256 spatial resolution, and the second at 64×64 latent resolution and 512×512 spatial resolution. Since, in some implementations, the base model 26 outputs tokens corresponding to a 16×16 latent map, the super-resolution model 38 can learn to “translate” the lower-resolution latent map to the higher-resolution latent map. This super-resolution model 38 can also be trained with text conditioning and cross-attention in a manner analogous to the base model.

The super-resolution visual token prediction model 38 can be trained using a second loss function, marked as 42 in FIG. 1. This loss function compares the tokens that were masked from the second set of conditioning tokens with the generated tokens from the second set of latent visual tokens. This comparison further refines the super-resolution model, ensuring that the high-resolution tokens accurately represent the tokens that were masked.

In some implementations, a variable masking rate, based on a Cosine scheduling, can also be employed in training the model. For example, for each training example, a masking rate r∈[0,1]can be sampled from a truncated arccos distribution with density function

$$p ( r ) = \frac{2}{π} {( 1 - {r}^{2} )}^{- \frac{1}{2}} .$$

This has an expected masking rate of 0.64, with a strong bias towards higher masking rates. The bias towards higher masking rates makes the prediction problem harder. In contrast with autoregressive approaches, which learn conditional distributions P(xᵢ|x_{<i}) for some fixed ordering of tokens, random masking with a variable masking ratio allows the proposed models to learn P(xᵢ|x_{Λ}) for arbitrary subsets of tokens A.

In some implementations, classifier-free guidance (CFG) is utilized to improve the model's generation quality and text-image alignment. For example, at training time, text conditioning can be removed on 10% of samples chosen randomly. At inference time, some example implementations compute a conditional logit [symbol] _{c} and an unconditional logit [symbol] ᵤ for each masked token. The model can then form the final logits [symbol] ^{g} by moving away from the unconditional logits by an amount t, the guidance scale:

$${ℓ}_{g} = ( 1 + t ) {ℓ}_{c} - t {ℓ}_{u} \qquad ( 1 )$$

Intuitively, CFG trades off diversity for fidelity. Different from previous approaches, some example implementations reduce the hit to diversity by linearly increasing the guidance scale t through the sampling procedure. This allows the early tokens to be sampled more freely, with low or no guidance, but increases the influence of the conditioning prompt for the later tokens.

Some example implementations also exploit this mechanism to enable negative prompting by replacing the unconditional logit [symbol] ᵤ with a logit conditioned on a “negative prompt”. This encourages the resulting image to have features associated with the positive prompt [symbol] _{c} and remove features associated with the negative prompt [symbol] ᵤ. Thus, the framework in FIG. 1 can be used to train a text-to-image generation model that employs a two-stage token prediction process, involving a base visual token prediction model and a super-resolution visual token prediction model. This process ensures the generation of high-quality images from textual prompts, while also allowing for efficient and scalable training of the model.

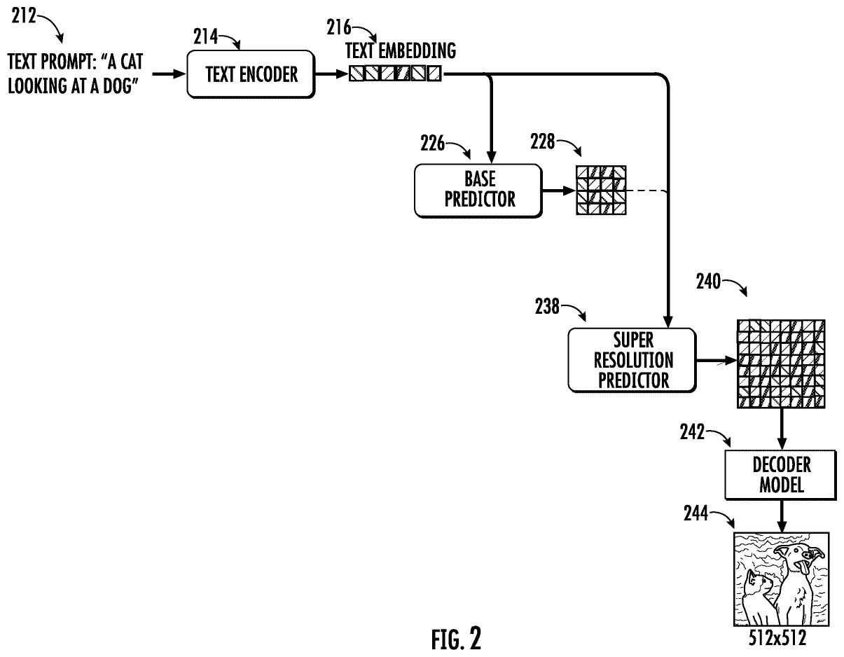

FIG. 2 illustrates the use of a trained text-to-image generation model to generate an output image 244 based on a textual prompt 212. FIG. 2 illustrates the structure of the model, which includes a base visual token prediction model 226, a super-resolution visual token prediction model 238, and a visual token decoder model 242. These three components work sequentially to generate the output image 244 from the text prompt 212.

The process begins with the receipt of a textual prompt 212, which is a textual description of the image content to be generated. This prompt is then processed by a pre-trained language model 214 to obtain a text embedding 216. The text embedding 216, which is a representation of the textual prompt in a latent space, carries rich information about the content to be depicted in the image. This text embedding 216 serves as the input to the base visual token prediction model 226.

The base visual token prediction model 226, as shown in FIG. 2, processes the text embedding 216 to predict a set of latent visual tokens 228. These tokens 228, represented at a first, lower resolution, capture the semantic content of the image at a coarse scale. The prediction of these tokens 228 is conditioned on the text embedding 216, ensuring that the generated tokens align with the content described by the textual prompt 212.

The first set of latent visual tokens 228 then serves as the input to the super-resolution visual token prediction model 238. This model is designed to translate the lower-resolution tokens 228 into a second set of latent visual tokens 240 represented at a higher resolution. This process is akin to enhancing the level of detail in the image representation, translating the coarse semantic content captured by the first set of tokens into a more refined and detailed representation in the second set of tokens 240.

In some implementations, the efficiency at which the model operates at inference time can be attributed to the use of parallel decoding (e.g., token prediction) to predict multiple output tokens in a single forward pass. Decoding (e.g., token prediction) can be performed at the base model 226 and/or the super-resolution model 238 based on a cosine schedule that chooses a certain fixed fraction of the highest confidence masked tokens to be predicted at that step. This allows, for example, the model to perform inference of 256 tokens using only 24 decoding steps in the base model and 4096 tokens using 8 decoding steps in the super-resolution model.

The final stage of the process involves the visual token decoder model 242. This model 242 takes the second set of latent visual tokens 240 as input and decodes them into a synthetic image 244. The decoder model 244 ensures that the image 244 generated aligns with the content described by the textual prompt 212, effectively decoding the high-dimensional token representation into a standard image format.

In some implementations, the decoder model 242 can be a decoder portion of a tokenizer model (e.g., VQGAN) that was used during training of the predictor model 238. In some implementations, to enhance the model's ability to generate fine details, the capacity of the decoder 242 can be increased by adding more residual layers and channels while maintaining the encoder capacity. The newly added decoder layers can then be finetuned, with the encoder weights, codebook, and base model and super-resolution model kept constant. This allows improvement in visual quality without re-training any other model components.

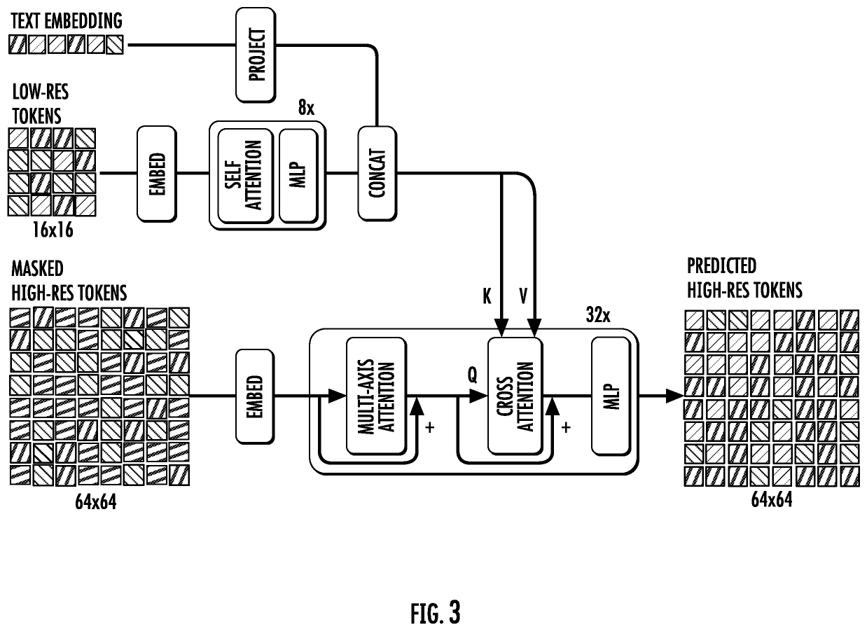

FIG. 3 illustrates an example architecture of a super-resolution model, providing a visual representation of the process by which the model enhances the resolution of the image tokens generated by the base visual token prediction model. The model's architecture includes a series of self-attention Transformer layers, which process low-resolution tokens. These low-resolution tokens, which are generated by the base visual token prediction model, represent the image content at a coarser scale. Upon processing by the self-attention Transformer layers, output embeddings are generated. These embeddings represent a higher-level understanding of the image content, capturing more detailed and specific features of the image.

Following the generation of the output embeddings, the model concatenates these embeddings with text embeddings. These text embeddings, extracted from the conditioning text prompt, carry semantic information about the content to be depicted in the image. The concatenation of the output embeddings and the text embeddings results in a combined representation that bridges the gap between the textual description and the visual representation.

The next stage of the super-resolution model, as depicted in FIG. 3, involves the application of cross-attention. This process applies attention from the concatenated embeddings to the masked high-resolution tokens. The masked high-resolution tokens represent the image content at a higher resolution but are incomplete, with some tokens being masked. The cross-attention process conditions the prediction of these masked tokens on the concatenated embeddings, ensuring that the predicted tokens align with both the low-resolution tokens and the text embeddings.

The super-resolution model learns to predict these masked tokens through a loss function. This loss function compares the predicted tokens with the actual tokens, refining the model's predictions over time. Through this process, the super-resolution model leams to translate the low-resolution tokens generated by the base visual token prediction model into high-resolution tokens that capture the image content at a more refined scale.

It should be noted that the architecture, operation, and performance of the super-resolution model, as described above and depicted in FIG. 3, are exemplary. Variations and modifications can be made to the model without departing from the scope of the present disclosure. For instance, the number and type of self-attention Transformer layers, the method of generating and processing the text embeddings, the specifics of the cross-attention process, and the nature of the loss function can be varied depending on the specific requirements and constraints of the application.

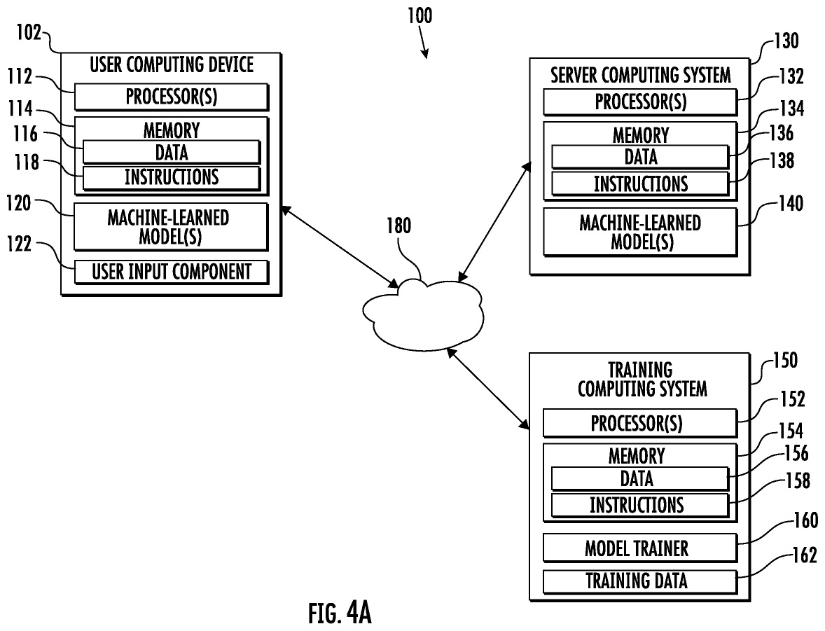

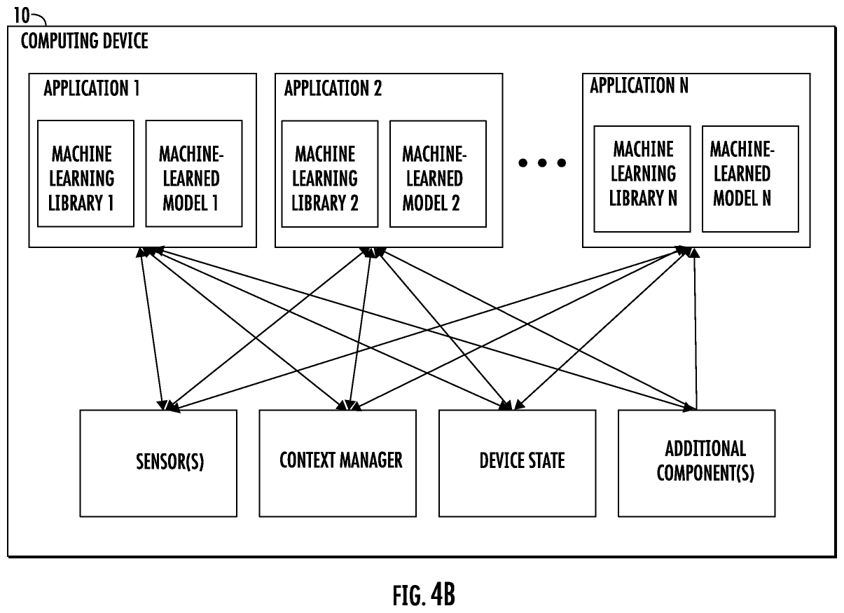

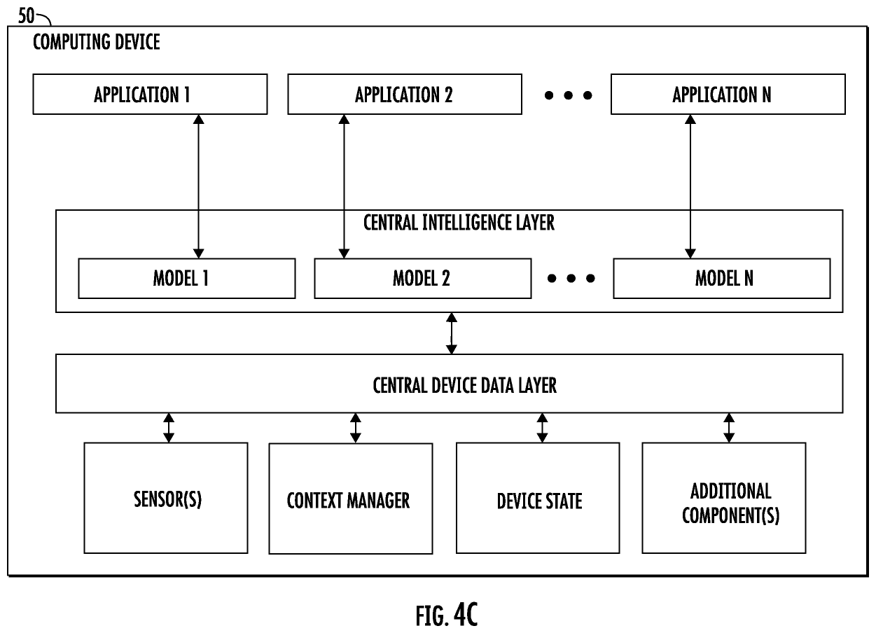

FIG. 4A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM. ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-2.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel image generation across multiple instances of inputs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an image generation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM. ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP. SMTP. FTP), encodings or formats (e.g., HTML, XML), and/or protection schemes (e.g., VPN, secure HTTP, SSL).

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications I through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system configured to perform text-to-image generation with improved computational efficiency, the computer system comprising:
one or more processors; and
one or more non-transitory computer-readable media that collectively store:
a machine-learned text-to-image generation model comprising a base visual token prediction model, a super-resolution visual token prediction model, and a visual token decoder model; and
instructions that, when executed by the computing system, cause the computing system to perform operations, the operations comprising:
obtaining a text embedding associated with a textual prompt that textually describes image content;
processing the text embedding with the base visual token prediction model to predict one or more of a first set of latent visual tokens that are associated with a first resolution;
processing the first set of latent visual tokens with the super-resolution visual token prediction model to generate one or more of a second set of latent visual tokens that are associated with a second resolution, the second resolution being greater than the first resolution; and
processing the second set of latent visual tokens with the visual token decoder model to generate a synthetic image, wherein the synthetic image depicts image content textually described by the textual prompt.

2. The computer system of claim 1, wherein obtaining the text embedding associated with the textual prompt comprises processing the textual prompt with a pre-trained language model.

3. The computer system of claim 1, wherein processing the text embedding with the base visual token prediction model to predict the one or more of the first set of latent visual tokens comprises processing one or more first masked image tokens with the base visual token prediction model conditioned on the text embedding to predict the one or more of the first set of latent visual tokens.

4. The computer system of claim 1, wherein processing the text embedding with the base visual token prediction model to predict the one or more of the first set of latent visual tokens comprises processing the text embedding with the base visual token prediction model to predict all of the first set of latent visual tokens.

5. The computer system of claim 1, wherein processing the text embedding with the base visual token prediction model to predict the one or more of the first set of latent visual tokens comprises processing the text embedding with the base visual token prediction model to predict a plurality of the first set of latent visual tokens, wherein the base visual token prediction model predicts at least two of the plurality of the first set of latent visual tokens in parallel.

6. The computer system of claim 1, wherein processing the text embedding with the base visual token prediction model to predict the one or more of the first set of latent visual tokens comprises processing one or more masked image tokens and one or more conditioning visual tokens with the base visual token prediction model conditioned on the text embedding to predict the one or more of the first set of latent visual tokens, wherein the first set of latent visual tokens include the one or more visual conditioning tokens and the one or more visual tokens predicted by the base visual token prediction model.

7. The computer system of claim 1, wherein the base visual token prediction model and the super-resolution visual token prediction model comprise transformer models.

8. The computer system of claim 1, wherein the base visual token prediction model and the super-resolution visual token prediction model have been jointly trained on a masked image modeling task.

9. The computer system of claim 8, wherein the masked image modeling task comprises predicting masked tokens given a set of conditioning tokens generated by vector-quantized tokenization models.

10. A computer-implemented method to train a text-to-image generation model, the text-to-image generation model comprising a base visual token prediction model and a super-resolution visual token prediction model, the method comprising:
obtaining, by a computing system comprising one or more computing devices, a training tuple comprising a textual prompt and a training image that depicts content described by the textual prompt;
processing, by the computing system, a lower-resolution version of the training image with a first tokenizer model to generate a first set of conditioning tokens:
masking, by the computing system, one or more of the first set of conditioning tokens to generate a first set of masked tokens;
processing, by the computing system, the first set of masked tokens with the base visual token prediction model conditioned on the text embedding to predict one or more of a first set of latent visual tokens that are associated with a first resolution;
training, by the computing system, the base visual token prediction model using a first loss function that compares the one or more of the first set of conditioning tokens that were masked with the one or more of the first set of latent visual tokens that are predicted by the base visual token prediction model;
processing, by the computing system, a higher-resolution version of the training image with a second tokenizer model to generate a second set of conditioning tokens;
masking, by the computing system, one or more of the second set of conditioning tokens to generate a second set of masked tokens:
processing, by the computing system, the second set of masked tokens and the first set of latent visual tokens with the super-resolution visual token prediction model to generate one or more of a second set of latent visual tokens that are associated with a second resolution, the second resolution being greater than the first resolution; and
training, by the computing system, the super-resolution visual token prediction model using a second loss function that compares the one or more of the second set of conditioning tokens that were masked with the one or more of the second set of latent visual tokens that are generated by the super-resolution visual token prediction model.

11. The computer-implemented method of claim 10, further comprising, processing the textual prompt with a pre-trained language model to generate the text embedding.

12. The computer-implemented method of claim 10, wherein the super-resolution visual token prediction model is further conditioned on the text embedding.

13. The computer-implemented method of claim 10, wherein masking, by the computing system, one or more of the first set of conditioning tokens to generate the first set of masked tokens comprises masking, by the computing system, two or more of the first set of conditioning tokens to generate the first set of masked tokens, and wherein the base visual token prediction model is configured to predict all of the two or more masked tokens in a single step.

14. The computer-implemented method of claim 10, wherein the base visual token prediction model and the super-resolution visual token prediction model comprise transformer models.

15. The computer-implemented method of claim 10, wherein the first tokenizer model and the second tokenizer model comprise vector-quantized generative adversarial networks.

16. The computer-implemented method of claim 10, further comprising finetuning a decoder network of the second tokenizer model to decode the second set of latent visual tokens to a synthetic image.

17. The computer-implemented method of claim 10, wherein masking, by the computing system, the one or more of the first set of conditioning tokens to generate the first set of masked tokens comprises masking, by the computing system, the one or more of the first set of conditioning tokens according to a variable masking rate.

18. The computer-implemented method of claim 10, wherein the method comprises, first, training, by the computing system, the base visual token prediction model using the first loss function and then, subsequently, training, by the computing system, the super-resolution visual token prediction model using the second loss function.

19. The computer-implemented method of claim 10, wherein the first loss function and the second loss function comprise cross-entropy loss functions.

20. One or more non-transitory computer-readable media that collectively store a text-to-image generation model, the text-to-image generation model comprising a base visual token prediction model and a super-resolution visual token prediction model, the text-to-image generation model having been trained by performance of training operations, the training operations comprising:
obtaining, by a computing system comprising one or more computing devices, a training tuple comprising a textual prompt and a training image that depicts content described by the textual prompt;
processing, by the computing system, a lower-resolution version of the training image with a first tokenizer model to generate a first set of conditioning tokens;
masking, by the computing system, one or more of the first set of conditioning tokens to generate a first set of masked tokens;
processing, by the computing system, the first set of masked tokens with the base visual token prediction model conditioned on the text embedding to predict one or more of a first set of latent visual tokens that are associated with a first resolution;
training, by the computing system, the base visual token prediction model using a first loss function that compares the one or more of the first set of conditioning tokens that were masked with the one or more of the first set of latent visual tokens that are predicted by the base visual token prediction model;
processing, by the computing system, a higher-resolution version of the training image with a second tokenizer model to generate a second set of conditioning tokens:
masking, by the computing system, one or more of the second set of conditioning tokens to generate a second set of masked tokens;
processing, by the computing system, the second set of masked tokens and the first set of latent visual tokens with the super-resolution visual token prediction model to generate one or more of a second set of latent visual tokens that are associated with a second resolution, the second resolution being greater than the first resolution; and
training, by the computing system, the super-resolution visual token prediction model using a second loss function that compares the one or more of the second set of conditioning tokens that were masked with the one or more of the second set of latent visual tokens that are generated by the super-resolution visual token prediction model.
